(19) United States
(12) Patent Application Publication
(10) Pub. No.: US 2026/0172353 A1
(43) Pub. Date: Jun. 18, 2026

(54) Wireless communication device and method for handling latency-sensitive traffic via aggregation control and traffic identifier assignment

(71) Applicant: MEDIATEK INC., Hsinchu City (TW)

(72) Inventors: Yen Chuang, Hsinchu City (TW); Cheng-Ying Wu, Hsinchu City (TW); Chi-Han Huang, Hsinchu City (TW)

(73) Assignee: MEDIATEK INC., Hsinchu City (TW)

(21) Appl. No.: 19/414,209

(22) Filed: Dec. 9, 2025

Related U.S. Application Data
(60) Provisional application No. 63/733,479, filed on Dec. 13, 2024.

(51) Int. Cl. H04L 47/11; H04L 47/56; H04W 28/02; H04W 80/02

(52) U.S. Cl. CPC H04L 47/11; H04L 47/56; H04W 28/0268; H04W 80/02

(57) ABSTRACT

A wireless communication device and method for data packet aggregation are provided. The device determines a traffic type for each MAC service data unit (MSDU) based on an explicit congestion notification (ECN) codepoint. The device forbears from aggregating a latency-sensitive MSDU and a non-latency-sensitive MSDU into a single aggregated MSDU (A-MSDU). Furthermore, the device assigns a first traffic identifier (TID) to latency-sensitive traffic and a second TID to non-latency-sensitive traffic. MPDUs associated with different TIDs are aggregated into a single multi-TID aggregated MPDU (A-MPDU) for transmission. By separating traffic into different logical channels while allowing physical aggregation, the receiver can utilize independent reordering buffers. This architecture effectively addresses Head-Of-Line (HOL) blocking caused by packet loss in non-latency-sensitive traffic, ensuring low latency and high reliability for L4S applications without sacrificing spectral efficiency.

### CROSS REFERENCE TO RELATED APPLICATIONS

This application claims the benefit of U.S. Provisional Application No. 63/733,479, filed on Dec. 13, 2024. The content of the application is incorporated herein by reference.

### BACKGROUND

With the evolution of wireless communication technologies, the requirements of various emerging applications for network transmission performance are increasing day by day. In addition to pursuing higher data throughput, applications such as cloud gaming, virtual reality (VR), augmented reality (AR), and real-time video conferencing have extremely stringent requirements for packet transmission latency and reliability. To meet these needs, the industry has proposed various technical architectures, such as “Low Latency, Low Loss, Scalable throughput (L4S)” technology.

The L4S architecture aims to distinguish traffic of different natures at the Internet protocol (IP) level through the explicit congestion notification (ECN) mechanism in the packet header. Generally, transmission flows supporting L4S are marked as L4S-capable, while traditional flows are considered classic traffic. When a network node detects congestion, it marks L4S packets specifically (e.g., marking them as Congestion Experienced, CE) to notify the sender to adjust the transmission rate in real-time, thereby maintaining low latency and reducing packet loss. To operate effectively, network equipment typically requires queue management mechanisms capable of distinguishing and isolating these two types of traffic.

However, in the practical operation of wireless local area networks (such as IEEE 802.11 standards or Wi-Fi systems), to improve spectral efficiency and throughput, the sender usually employs aggregation techniques to combine multiple data units (e.g., MAC service data units (MSDUs)) into a larger aggregated frame (e.g., aggregated MSDU (A-MSDU) or aggregated MPDU (A-MPDU)) for transmission. In existing implementations, aggregation operations often fail to fully consider the intrinsic differences in latency requirements between L4S traffic and classic traffic. If L4S packets with strict low-latency requirements are mixed and aggregated in the same frame with classic packets that are less sensitive to latency, the transmission timeliness and reliability of the L4S traffic may be compromised.

Furthermore, wireless communication devices typically allocate packets to corresponding access category (AC) queues for transmission based on a traffic identifier (TID). In traditional designs, L4S traffic and classic traffic may be allocated to the same TID or share the same transmission queue. When these two types of traffic share the same logical channel, the receiver may face issues during the process of packet reordering. For example, if a packet of the classic traffic is lost during transmission, the reordering buffer at the receiver must wait for the retransmission of the lost packet, which causes subsequent arrived L4S packets to be forced to remain in the buffer and unable to be delivered. This phenomenon is known as Head-Of-Line (HOL) blocking, which severely impacts the user experience of low-latency applications. Therefore, how to effectively support the L4S architecture in wireless communication systems while solving the problems of mixed aggregation and blocking has become an urgent issue for the industry to resolve.

### SUMMARY

An embodiment of the present invention provides a wireless communication device. The wireless communication device comprises one or more memory units, a transceiver, and one or more processors. The one or more processors are coupled to the one or more memory units and the transceiver, and are configured to execute instructions stored in the one or more memory units to cause the wireless communication device to: obtain a plurality of MAC service data units (MSDUs); determine a traffic type for each of the plurality of MSDUs based on an explicit congestion notification (ECN) codepoint in an Internet protocol (IP) header thereof, wherein the traffic type is classified as either a latency-sensitive traffic type or a non-latency-sensitive traffic type; forbear from aggregating a first MSDU and a second MSDU from the plurality of MSDUs in response to a determination that the traffic type of the first MSDU is the latency-sensitive traffic type and the traffic type of the second MSDU is the non-latency-sensitive traffic type; aggregate at least two MSDUs from the plurality of MSDUs to form a single aggregated MSDU (A-MSDU) in response to a determination that the at least two MSDUs are all of the latency-sensitive traffic type or are all of the non-latency-sensitive traffic type; and cause the transceiver to transmit a data unit comprising the single A-MSDU.

Another embodiment of the present invention provides a method for data packet aggregation performed by a wireless communication device. The method comprises obtaining a plurality of MAC service data units (MSDUs); determining a traffic type for each of the plurality of MSDUs based on an explicit congestion notification (ECN) codepoint in an Internet protocol (IP) header thereof, wherein the traffic type is classified as either a latency-sensitive traffic type or a non-latency-sensitive traffic type; forbearing from aggregating a first MSDU and a second MSDU from the plurality of MSDUs in response to a determination that the traffic type of the first MSDU is the latency-sensitive traffic type and the traffic type of the second MSDU is the non-latency-sensitive traffic type; aggregating at least two MSDUs from the plurality of MSDUs to form a single aggregated MSDU (A-MSDU) in response to a determination that the at least two MSDUs are all of the latency-sensitive traffic type or are all of the non-latency-sensitive traffic type; and transmitting, via a transceiver, a data unit comprising the single A-MSDU.

An embodiment of the present invention provides a wireless communication device. The wireless communication device comprises one or more memory units, a transceiver, and one or more processors. The one or more processors are coupled to the one or more memory units and the transceiver, and are configured to execute instructions stored in the one or more memory units to cause the wireless communication device to: obtain a plurality of MAC service data units (MSDUs); determine a traffic type for each of the plurality of MSDUs based on an explicit congestion notification (ECN) codepoint in an Internet protocol (IP) header thereof, wherein the traffic type is classified as either a latency-sensitive traffic type or a non-latency-sensitive traffic type; assign a first traffic identifier (TID) to one or more MSDUs of the latency-sensitive traffic type; assign a second TID, different from the first TID, to one or more MSDUs of the non-latency-sensitive traffic type; aggregate at least one first MAC Protocol Data Unit (MPDU) associated with the first TID and at least one second MPDU associated with the second TID to form a single multi-TID aggregated MPDU (A-MPDU); and cause the transceiver to transmit a data unit comprising the single multi-TID A-MPDU.

Another embodiment of the present invention provides a method for data packet aggregation performed by a wireless communication device. The method comprises obtaining a plurality of MAC service data units (MSDUs); determining a traffic type for each of the plurality of MSDUs based on an explicit congestion notification (ECN) codepoint in an Internet protocol (IP) header thereof, wherein the traffic type is classified as either a latency-sensitive traffic type or a non-latency-sensitive traffic type; assigning a first traffic identifier (TID) to one or more MSDUs of the latency-sensitive traffic type; assigning a second TID, different from the first TID, to one or more MSDUs of the non-latency-sensitive traffic type; aggregating at least one first MAC Protocol Data Unit (MPDU) associated with the first TID and at least one second MPDU associated with the second TID to form a single multi-TID aggregated MPDU (A-MPDU); and transmitting, via a transceiver, a data unit comprising the single multi-TID A-MPDU.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a wireless communication system according to an embodiment of the present invention.

FIG. 2 is a table defining explicit congestion notification (ECN) codepoints according to an embodiment of the present invention.

FIG. 3 is a schematic diagram illustrating a data processing flow according to an embodiment of the present invention.

FIG. 4 is a table illustrating aggregation rules according to an embodiment of the present invention.

FIG. 5 is a flowchart illustrating a method for data packet aggregation according to an embodiment of the present invention.

FIG. 6 is a schematic diagram illustrating a data processing flow according to another embodiment of the present invention.

FIG. 7 is a schematic diagram illustrating a multi-traffic identifier (multi-TID) transmission and reception reordering architecture according to an embodiment of the present invention.

FIG. 8 is a schematic diagram illustrating a data structure of a physical layer protocol data unit (PPDU) according to an embodiment of the present invention, which includes a multi-TID A-MPDU.

FIG. 9 is a flowchart illustrating a transmission method based on traffic identifier (TID) distribution and aggregation according to an embodiment of the present invention.

### DETAILED DESCRIPTION

Hereinafter, wireless communication devices, methods, and computer-readable storage media according to embodiments of the present invention will be described with reference to the accompanying drawings. In the drawings or description, similar or identical elements will be denoted by the same reference numerals as much as possible. It should be noted that the drawings are merely schematic and are not drawn to actual scale, and only elements related to the present invention are shown, while other elements may be omitted to simplify the drawings. Furthermore, the embodiments disclosed below are merely illustrative and are not intended to limit the scope of the present invention.

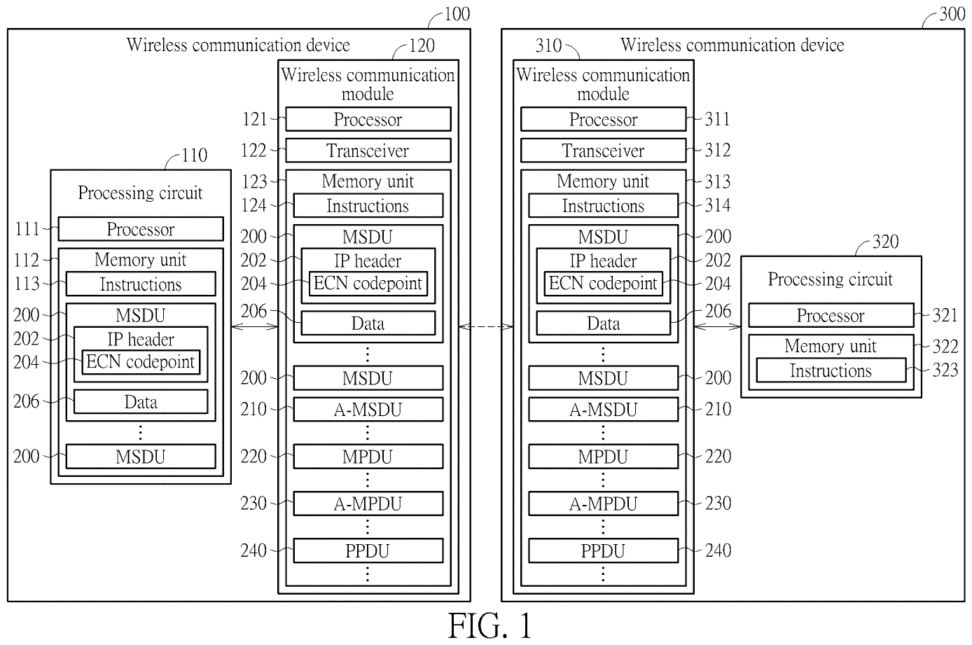

FIG. 1 is a functional block diagram illustrating a wireless communication system according to an embodiment of the present invention. The wireless communication system comprises a wireless communication device 100 and another wireless communication device 300 communicating wirelessly with the wireless communication device 100. In this embodiment, the wireless communication device 100 may serve as a transmitter, and the wireless communication device 300 may serve as a receiver. However, the present invention is not limited thereto; both the wireless communication device 100 and the wireless communication device 300 may possess both transmission and reception functions simultaneously.

It should be particularly noted that although this embodiment may be described using a wireless local area network (WLAN) or a Wi-Fi® system as an example, the wireless communication device 100 and the wireless communication device 300 are not limited to Wi-Fi® devices. The wireless communication device 100 and the wireless communication device 300 may be electronic devices supporting various wireless communication protocols, such as wireless access points (APs) or stations (STAs) supporting the IEEE 802.11 series standards; or base stations or user equipment (UE) supporting 3GPP® standards (e.g., 4G LTE, 5G NR, 6G); or devices supporting other communication protocols such as Bluetooth® or ZigBee®. Their physical forms may include, but are not limited to, smartphones, tablet computers, laptop computers, desktop computers, routers, gateways, servers, wearable devices (e.g., augmented reality (AR) or virtual reality (VR) head-mounted displays), automotive electronic devices, or Internet of things (IoT) devices.

The wireless communication device 100 comprises a processing circuit 110 and a wireless communication module 120. The processing circuit 110 is coupled to the wireless communication module 120. The processing circuit 110 comprises a processor 111 and a memory unit 112. The memory unit 112 stores instructions 113 and data to be transmitted. The processor 111 is configured to access the memory unit 112 and execute the instructions 113 to control the operation of the wireless communication device 100. In one embodiment of the present invention, the processor 111 may be regarded as a host processor, which may cooperate with a processor 121 of the wireless communication module 120 to collectively execute the method steps described in the embodiments of the present invention (e.g., traffic classification, aggregation determination, or transmission control).

In embodiments of the present invention, the processor 111 and the processor 121 may be implemented by various circuit elements possessing computing capabilities, such as a central processing unit (CPU), a microprocessor, a microcontroller (MCU), a digital signal processor (DSP), an application specific integrated circuit (ASIC), a field programmable gate array (FPGA), a complex programmable logic device (CPLD), dedicated logic circuits, or a combination of the above elements. The memory unit 112 and a memory unit 123 may include volatile storage media or non-volatile storage media, such as random access memory (RAM), static RAM (SRAM), dynamic RAM (DRAM), read-only memory (ROM), flash memory, hard disk drive (HDD), solid state drive (SSD), or any element capable of storing digital information.

In FIG. 1, the memory unit 112 stores a plurality of MAC service data units (MSDUs) 200. Each MSDU 200 includes an Internet protocol header (IP header) 202 and data 206. The IP header 202 contains an explicit congestion notification (ECN) codepoint 204. The ECN codepoint 204 is used to indicate the traffic type of the MSDU 200, for example, whether it is latency-sensitive traffic or supports L4S (Low Latency, Low Loss, Scalable throughput) functionality.

The wireless communication module 120 comprises the processor 121, a transceiver 122, and the memory unit 123. Each of the wireless communication module 120 and the wireless communication module 310 may each be, for example, a network interface card (NIC) or a communication chip. The processor 121 is configured to access the memory unit 123 and execute instructions 124 (e.g., firmware) stored therein to perform processing operations of the medium access control layer (MAC layer) and the physical layer (PHY), such as baseband signal processing, packet scheduling, aggregation, and de-aggregation. The implementation of the processor 121 may be similar to that of the aforementioned processor 111; for example, it may be a baseband processor or a MAC processor. The memory unit 123 is used to temporarily store the MSDUs 200 from the processing circuit 110 and perform subsequent aggregation or queuing operations. The implementation of the memory unit 123 may also be similar to that of the aforementioned memory unit 112; for example, it may be an on-chip buffer memory or registers. The transceiver 122 includes radio frequency (RF) front-end circuits, such as power amplifiers, low-noise amplifiers, filters, mixers, and antennas, for transmitting and receiving wireless signals.

As shown in FIG. 1, the memory unit 123 of the wireless communication module 120 illustrates the structural evolution of data units during the transmission process. The processor 121 (or in cooperation with the processor 111) may aggregate multiple MSDUs 200 into a single aggregated MSDU (A-MSDU) 210. Subsequently, the MSDU 200 or the A-MSDU 210 may be encapsulated into a MAC Protocol Data Unit (MPDU) 220. The processor 121 may also aggregate multiple MPDUs 220 into a single aggregated MPDU (A-MPDU) 230. Thereafter, the A-MPDU 230 may be encapsulated into a physical layer protocol data unit (PPDU) 240 and transmitted via the transceiver 122 over the radio to the wireless communication device 300.

The wireless communication device 300 has a hardware architecture similar to that of the wireless communication device 100, including a wireless communication module 310 and a processing circuit 320. The wireless communication module 310 comprises a processor 311, a transceiver 312, and a memory unit 313. The memory unit 313 stores instructions 314. The processing circuit 320 comprises a processor 321 and a memory unit 322, wherein the memory unit 322 stores instructions 323. Regarding specific implementation types of each processor and memory unit of the wireless communication device 300, the descriptions are the same as those for the corresponding elements of the aforementioned wireless communication device 100 and will not be repeated here. The processor 311 and the processor 321 are respectively configured to execute the instructions 314 and the instructions 323 to control the processing operations of the wireless communication device 300. When the wireless communication device 300 receives the PPDU 240 from the wireless communication device 100, the wireless communication module 310 performs de-aggregation and de-encapsulation operations to restore the data to at least one of the A-MPDU 230, MPDU 220, A-MSDU 210, and MSDU 200, and transmits the MSDUs 200 to the processing circuit 320 for upper-layer protocol processing.

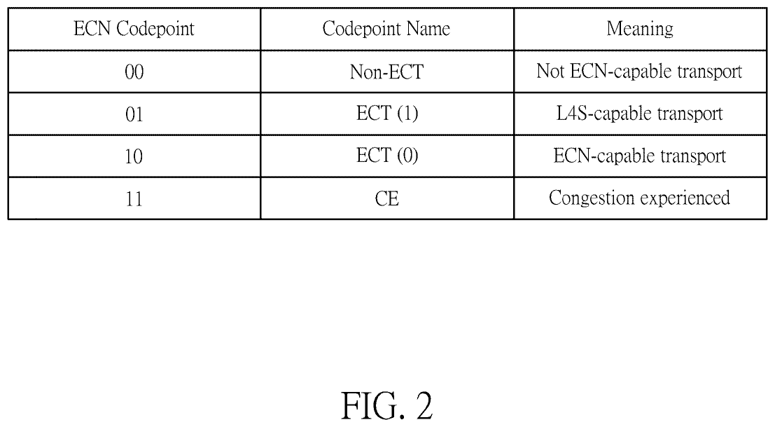

FIG. 2 is a table defining explicit congestion notification (ECN) codepoints according to an embodiment of the present invention. Please refer to FIG. 1 and FIG. 2 together. The IP header 202 of the MAC service data unit (MSDU) 200 shown in FIG. 1 contains a 2-bit ECN field, namely the ECN codepoint 204. The processor 111 of the processing circuit 110 or the processor 121 of the wireless communication module 120 can read the ECN codepoint 204 and determine the traffic type to which the MSDU 200 belongs according to the definition table shown in FIG. 2.

As shown in FIG. 2, the definition table includes three columns: “ECN Codepoint”, “Codepoint Name”, and “Meaning”. The ECN Codepoint column lists four possible binary value combinations of the 2-bit ECN field; the Codepoint Name column lists the corresponding standard names; and the Meaning column explains the transmission status represented by the value.

Specifically, the value “00” corresponds to the Non-ECT codepoint, meaning that the MSDU 200 belongs to a not ECN-capable transport; the value “10” corresponds to the ECT(0) codepoint, meaning that the MSDU 200 supports standard ECN functionality. In an embodiment of the present invention, when the ECN codepoint 204 in the IP header 202 of the MSDU 200 is “00” or “10”, the MSDU 200 is classified as a non-latency-sensitive traffic type, which may also be referred to as classic traffic.

Furthermore, the value “01” corresponds to the ECT(1) codepoint (L4S-capable transport), meaning that the MSDU 200 is sent by a transport layer supporting L4S (Low Latency, Low Loss, Scalable throughput) functionality; the value “11” corresponds to the Congestion Experienced (CE) codepoint, meaning that the MSDU 200 has experienced network congestion on the transmission path and has been marked. In an embodiment of the present invention, when the ECN codepoint 204 in the IP header 202 of the MSDU 200 is “01” or “11”, the MSDU 200 is classified as a latency-sensitive traffic type, which may also be referred to as L4S traffic. By identifying the ECN codepoint 204, the first wireless communication device 100 can divert traffic of different natures to different queues or employ different aggregation strategies to meet the low-latency requirements of L4S traffic.

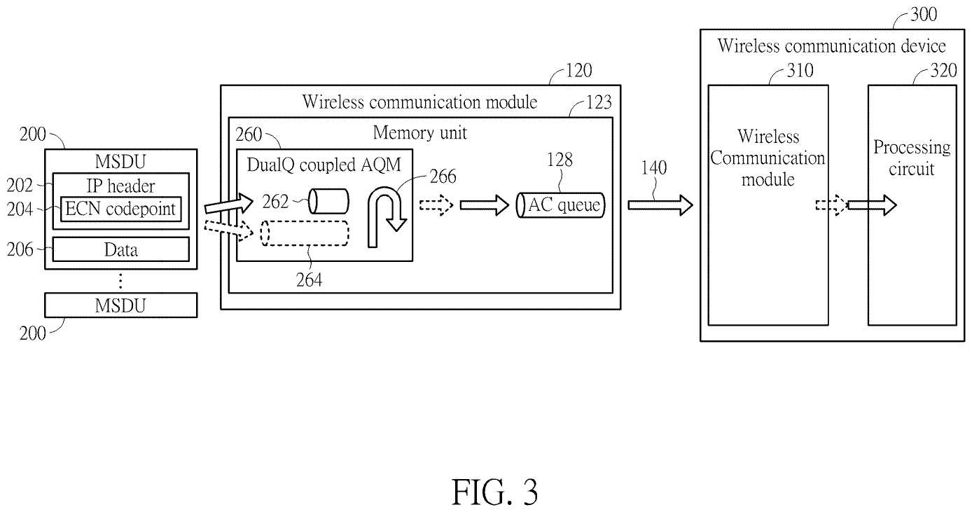

FIG. 3 is a schematic diagram illustrating a data processing flow according to an embodiment of the present invention. In this embodiment, the classification of L4S traffic and queue management are performed by the wireless communication module 120. Please refer to FIG. 1 and FIG. 3 together. The processing circuit 110 transmits the generated MAC service data unit (MSDU) 200 to the wireless communication module 120. The processor 121 of the wireless communication module 120 is configured to execute the instructions 124 stored in the memory unit 123 to implement the functions of a dual queue coupled active queue management (DualQ coupled AQM) module 260 as shown in FIG. 3.

As shown in FIG. 3, the DualQ coupled AQM module 260 includes a first queue 262, a second queue 264, and a coupling mechanism 266. The wireless communication module 120 diverts each MSDU 200 to the corresponding queue based on its traffic type. Specifically, in one exemplary embodiment, if the processor 121 interprets the ECN codepoint 204 in the IP header 202 of the MSDU 200 as “01” (ECT(1)) or “11” (CE), it may identify it as latency-sensitive traffic and store it in the first queue 262; if it interprets the ECN codepoint 204 as “00” (Not-ECT) or “10” (ECT(0)), it may identify it as non-latency-sensitive traffic and store it in the second queue 264. However, the present invention is not limited to this specific allocation method. In other embodiments, the mapping relationship between the ECN codepoints and the traffic types, as well as the classification rules for directing traffic to the first queue 262 or the second queue 264, may be adjusted or configured according to system requirements, network policies, or specific standard definitions. For instance, the processor 121 may be configured to identify specific ECN codepoints (e.g., only ECT(1)) as the latency-sensitive traffic type. Alternatively, specific traffic other than ECN-marked traffic could also be directed to the first queue 262 if it meets certain latency criteria. In the figure, the first queue 262 is represented by a solid cylinder, and the second queue 264 is represented by a dashed cylinder.

The coupling mechanism 266 comprises a coupled queue management unit and a scheduler, such as a Conditional Priority Scheduler (CPS). In one embodiment of the present invention, the DualQ coupled AQM module 260 may follow the technical specification defined in RFC 9332, ‘Dual-Queue Coupled Active Queue Management (AQM) for Low Latency, Low Loss, and Scalable Throughput (L4S)’ published by the Internet Engineering Task Force (IETF). In addition, the first queue 262 may serve as the L4S queue defined in RFC 9332, and the second queue 264 may serve as the Classic queue defined in RFC 9332. Specifically, the coupled queue management unit includes an L4S Active Queue Management (L-AQM) associated with the first queue 262 and a Classic Active Queue Management (C-AQM) associated with the second queue 264. The scheduler (e.g., CPS) is configured to schedule the transmission of packets from the first queue 262 and the second queue 264 based on the management of the L-AQM and the C-AQM. The coupling mechanism 266 is configured to correlate the congestion states of the first queue 262 and the second queue 264 to address fairness issues when different traffic types coexist. Since L4S traffic (first queue 262) aims to maintain extremely low queuing delay, while traditional traffic (second queue 264) typically builds up a larger queue buffer, the coupling mechanism 266 monitors the queuing delay or depth of both the first queue 262 and the second queue 264. Specifically, the L-AQM and the C-AQM calculate respective congestion results for the first queue 262 and the second queue 264. The coupling mechanism 266 utilizes an interaction mechanism between the L-AQM and the C-AQM to reference these results and calculate a congestion handling probability for the latency-sensitive traffic. The congestion handling may involve marking packets (e.g., as Congestion Experienced (CE)) or dropping packets. For example, when congestion occurs in the second queue 264 or in the first queue 262, the coupling mechanism 266 increases the probability of packets in the first queue 262 being marked as Congestion Experienced (CE) or being dropped, thereby notifying the sender to reduce the transmission rate or discarding excess traffic, ensuring that L4S traffic maintains low latency without occupying excessive bandwidth, thus allowing the classic traffic to obtain a weighted fair or conditionally fair share of resources.

Packets scheduled by the DualQ coupled AQM module 260 are sent to an access category (AC) queue 128. The AC queue 128 is located in the memory unit 123 of the wireless communication module 120 and is used to temporarily store data ready for wireless transmission. During this process, i.e., on the path from the DualQ coupled AQM module 260 to the AC queue 128, the processor 121 may perform aggregation operations on the packets, such as aggregating multiple MSDUs 200 into an aggregated MSDU (A-MSDU) 210. Subsequently, the data in the AC queue 128 (e.g., A-MSDU 210 encapsulated in an MPDU) is finally encapsulated into a physical layer protocol data unit (PPDU) 240, transmitted via the transceiver 122 through a transmission process 140 to the wireless communication module 310 of the receiver, and processed by the processing circuit 320 of the receiver.

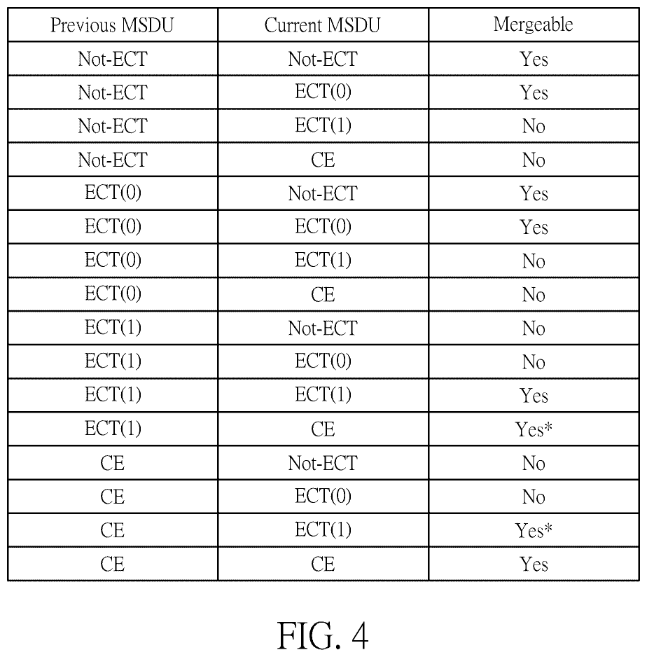

FIG. 4 is a table illustrating aggregation rules according to an embodiment of the present invention. Please refer to FIG. 1, FIG. 2, FIG. 3, and FIG. 4 together. When the processor 111 of the processing circuit 110 or the processor 121 of the wireless communication module 120 performs an aggregation operation (e.g., A-MSDU aggregation), it determines whether a currently received MAC service data unit (MSDU) 200 can be merged with an MSDU 200 previously received and temporarily stored in a buffer (e.g., the first queue 262 or the second queue 264 in FIG. 3) based on the rule table shown in FIG. 4.

As shown in FIG. 4, the aggregation rule table includes three columns: “Previous MSDU”, “Current MSDU”, and “Mergeable”. The “Previous MSDU” column represents the traffic type of the MSDU currently existing at the end of the aggregation queue; the “Current MSDU” column represents the traffic type of the newly received MSDU ready for aggregation determination; and the “Mergeable” column indicates whether, under the combination of these two traffic types, it is permitted to aggregate the current MSDU into the aggregated frame (e.g., A-MSDU 210) where the previous MSDU is located. The determination of the traffic type is based on the ECN codepoint 204 in the IP header 202 of each MSDU 200 (as shown in FIGS. 1 and 2).

According to the rules in FIG. 4, when both the previous MSDU and the current MSDU belong to the non-latency-sensitive traffic type (referring to FIG. 2, e.g., ECN codepoint is “Not-ECT” or “ECT(0)”), their corresponding “Mergeable” column indicates permitted (Yes). Similarly, when both the previous MSDU and the current MSDU belong to the L4S traffic of the latency-sensitive traffic type (referring to FIG. 2, e.g., ECN codepoint is “ECT(1)”), aggregation is also permitted. However, if the previous MSDU and the current MSDU belong to different traffic type categories (e.g., one is “Not-ECT” and the other is “ECT(1)” or “CE”), their corresponding “Mergeable” column indicates not permitted (No), meaning that the processor should forbear from aggregating the two to avoid latency-sensitive traffic being affected by non-latency-sensitive traffic.

Additionally, in FIG. 4, for specific combinations involving Congestion Experienced (CE) packets (e.g., “ECT(1)” mixed with “CE”, or “CE” mixed with “ECT(1)”), the “Mergeable” column is marked as “Yes*”. The asterisk here indicates a conditional permission. In some embodiments, if the system designer wishes to provide higher transmission reliability for packets experiencing congestion, this rule can be set to “No”, i.e., not aggregating normal L4S packets with packets experiencing congestion, to avoid the loss of congestion signals due to the loss of aggregated packets. The processor 111 or 121 can dynamically adjust the aggregation decision for such combinations based on system settings or current network conditions.

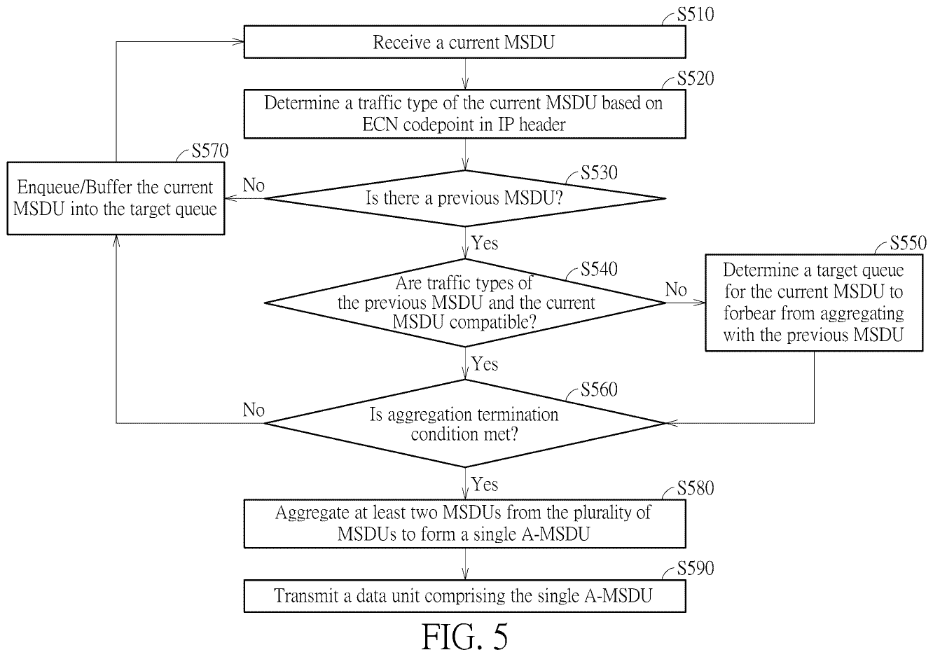

FIG. 5 is a flowchart illustrating a method for data packet aggregation according to an embodiment of the present invention. The method of this embodiment is applicable to the wireless communication device 100 and may be executed by the processor 121 of the wireless communication module 120 alone, or implemented by the processor 121 in cooperation with the processor 111 of the processing circuit 110 executing instructions 113 stored in the memory unit 112. This method aims to ensure that traffic of different natures (especially L4S traffic and classic traffic) are not mixed and aggregated into the same data unit, so as to maintain the transmission quality of latency-sensitive traffic.

First, in step S510, the processor 121 receives a current MSDU 200. Next, in step S520, the processor 121 determines the traffic type of the current MSDU 200 based on the ECN codepoint 204 in the IP header 202 of the current MSDU 200. As shown in FIG. 2, if the ECN codepoint indicates “ECT(1)” or “CE”, it is determined that the traffic type of the current MSDU 200 is the latency-sensitive traffic type; if it indicates “Not-ECT” or “ECT(0)”, it is determined that the traffic type of the current MSDU 200 is the non-latency-sensitive traffic type.

In step S530, the processor 121 determines whether a previous MSDU exists in the buffer (e.g., the queue 262 or 264). Here, “previous MSDU” refers to an MSDU received before the reception of the current MSDU 200 and currently still temporarily stored in the buffer waiting for aggregation (typically the last MSDU in the queue 262 or 264). If it is determined in step S530 that there is no previous MSDU, the flow proceeds to step S570. If it is determined in step S530 that there is a previous MSDU, the flow proceeds to step S540.

In step S540, the processor 121 determines whether the traffic types of the previous MSDU and the current MSDU are compatible. This determination is based on the aggregation rule table shown in FIG. 4. Specifically, if both belong to the latency-sensitive traffic type, or both belong to the non-latency-sensitive traffic type, the processor 121 determines that the traffic types are compatible. Conversely, if the two belong to different traffic types (e.g., one is latency-sensitive and the other is non-latency-sensitive), it is determined that the traffic types are incompatible.

If it is determined in step S540 that the traffic types are incompatible, the flow proceeds to step S550. In step S550, the processor 121 determines a target queue for the current MSDU to forbear from aggregating the current MSDU with the previous MSDU. Referring to FIG. 3, if the previous MSDU is temporarily stored in the first queue 262, and the current MSDU is determined to be incompatible non-latency-sensitive traffic, the processor 121 identifies the second queue 264 as the target queue; conversely, if the previous MSDU is in the second queue 264 and the current MSDU is latency-sensitive traffic, the processor 121 identifies the first queue 262 as the target queue. Since the current MSDU and the previous MSDU are assigned to two physically or logically independent queues (i.e., the first queue 262 and the second queue 264), they cannot be merged in an A-MSDU aggregation operation performed for a single queue, thereby achieving the purpose of forbearing from aggregation.

If it is determined in step S540 that the traffic types are compatible, the flow proceeds to step S560. In step S560, the processor 121 determines whether an aggregation termination condition is met. The aggregation termination condition may include, but is not limited to: whether the aggregated data length reaches an upper limit, whether an aggregation timer expires, or whether the number of packets in the queue reaches a threshold.

If step S530 determines that there is no previous MSDU, or step S560 determines that the aggregation termination condition is not met, the flow proceeds to step S570. Note that the target queue corresponds to the traffic type of the current MSDU. For example, if the traffic type of the current MSDU is the latency-sensitive traffic type, the target queue is the first queue 262; if the traffic type of the current MSDU is the non-latency-sensitive traffic type, the target queue is the second queue 264. Specifically, if step S530 determines that there is no previous MSDU, the target queue is determined based on the traffic type of the current MSDU. If the processor 121 determines that the traffic types are compatible in step S540, the target queue is the same queue storing the previous MSDU. If the processor 121 determines that the traffic types are incompatible in step S540 (and thus executes step S550), the target queue is the one identified in step S550. In step S570, the processor 121 enqueues or buffers the current MSDU 200 into the target queue, waiting for subsequent aggregation processing. After completing step S570, the flow returns to step S510 to process the next incoming MSDU.

In other embodiments, the target queue may be determined in step S520, and step S550 may be omitted. In such cases, if it is determined in step S540 that the traffic types are incompatible, the flow still proceeds to step S560. By directing the flow to step S560 regardless of whether the traffic types are compatible, the wireless communication device ensures that the aggregation termination condition is consistently evaluated for the target queue (determined in step S520). This means that even if the traffic types are incompatible, the system still checks whether the aggregation termination condition is met. If the termination condition is met, the system proceeds to step S580 to execute aggregation and transmission to clear the buffer, thereby actively preventing data overflow in the target queue.

If it is determined in step S560 that the aggregation termination condition is met, the flow proceeds to step S580. In step S580, the processor 121 aggregates at least two MSDUs from the target queue (i.e., the first queue 262 or the second queue 264) to form a single A-MSDU 210. The condition for aggregating at least two MSDUs here is based on the accumulation mechanism of the preceding steps: when step S560 determines that the condition is not met, the flow returns to step S510 via step S570 to receive the next MSDU. In this loop, if step S530 determines that a previous MSDU exists and step S540 determines that the current MSDU is compatible with the traffic type of the previous MSDU, the current MSDU will be added to the queue where the previous MSDU is located. Therefore, the target queue will contain at least the previous MSDU and the current MSDU, ensuring the quantity condition for aggregation. Finally, in step S590, the processor 121 causes the transceiver 122 to transmit a data unit (e.g., PPDU 240) comprising the single A-MSDU 210.

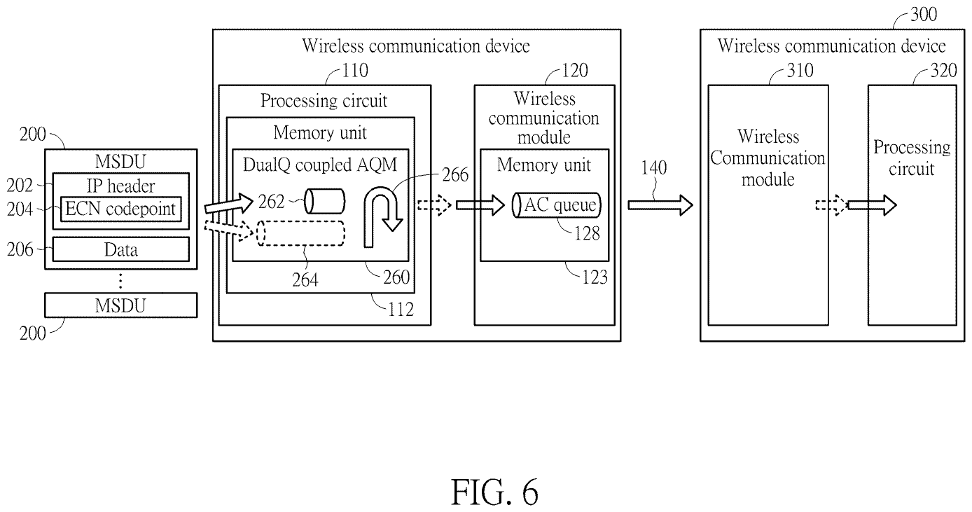

FIG. 6 is a schematic diagram illustrating a data processing flow according to a second embodiment of the present invention. In this embodiment, the DualQ coupled AQM module 260 is implemented in the processing circuit 110 of the wireless communication device 100, rather than in the wireless communication module 120. This architecture typically corresponds to an application scenario where L4S traffic management is performed by a driver on the host side.

Please refer to FIG. 1 and FIG. 6 together. The processor 111 of the processing circuit 110 is configured to execute the instructions 113 stored in the memory unit 112 to establish and maintain the DualQ coupled AQM module 260 in the memory unit 112. When the processing circuit 110 generates or receives an MSDU 200 from an upper-layer application, the processor 111 diverts it based on the traffic type of the MSDU 200 (e.g., reading the ECN codepoint in the IP header). If determined as latency-sensitive traffic, it is stored in the first queue 262 located in the memory unit 112; if determined as non-latency-sensitive traffic, it is stored in the second queue 264 located in the memory unit 112. Similarly, the processor 111 executes the logic of the coupling mechanism 266 to monitor the state of the second queue 264 and manage the packets in the first queue 262 accordingly (e.g., marking congestion experience).

After scheduling at the processing circuit 110 side, the processor 111 transmits the MSDUs 200 to the wireless communication module 120. The processor 121 of the wireless communication module 120 receives the MSDUs 200 from the processing circuit 110. In this embodiment, the processor 121 is configured to perform an aggregation operation (e.g., A-MSDU aggregation) on the MSDUs 200 before storing the MSDUs 200 into the access category (AC) queue 128. That is, the processor 121 aggregates the received multiple MSDUs 200 into an aggregated frame and then temporarily stores it in the AC queue 128 in the memory unit 123. Subsequently, the data in the AC queue 128 (e.g., A-MSDU 210 already encapsulated in an MPDU) is finally encapsulated by the wireless communication module 120 into a physical layer protocol data unit (PPDU) 240, transmitted via the transceiver 122 to the wireless communication module 310 of the receiver, and processed by the processing circuit 320 of the receiver.

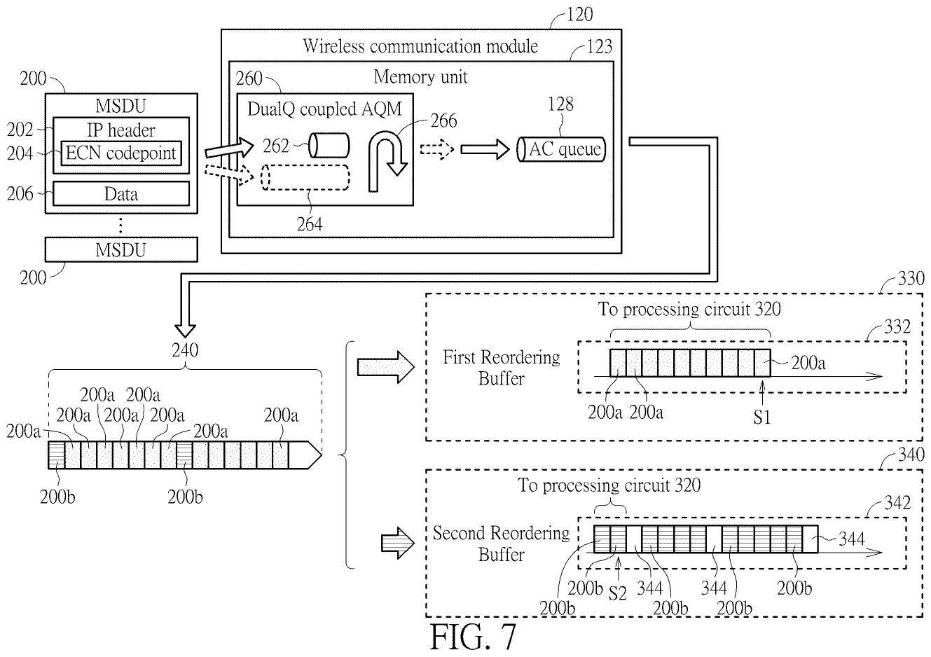

FIG. 7 is a schematic diagram illustrating a multi-traffic identifier (multi-TID) transmission and reception reordering architecture according to an embodiment of the present invention. This embodiment demonstrates how to use multi-TID to solve the head-of-line (HOL) blocking problem at the receiver, especially for L4S traffic that is extremely sensitive to latency.

Please refer to FIG. 7. In the wireless communication module 120 of the wireless communication device 100 at the transmitting end, a DualQ coupled AQM module 260 and an AC queue 128 are configured. To effectively isolate traffic of different natures, this embodiment maps different traffic types to different traffic identifiers (TIDs). Specifically, the first queue 262 is configured to temporarily store first MSDUs 200a belonging to a first traffic type (e.g., latency-sensitive traffic or L4S traffic), and the first queue 262 corresponds to a first TID. The second queue 264 is configured to temporarily store second MSDUs 200b belonging to a second traffic type (e.g., non-latency-sensitive traffic or classic traffic), and the second queue 264 corresponds to a second TID.

In an embodiment of the present invention, the wireless communication module 120 can obtain the second TID different from the first TID in various ways to ensure the independence of the two types of traffic on the logical transmission channel. According to the IEEE 802.11 standard, TIDs typically define 16 values (i.e., 0 to 15), where values 0 to 7 are usually mapped to 4 different access categories (ACs), while values 8 to 15 are often considered reserved or unused values. These four Access Categories are typically defined to support differentiated Quality of Service (QoS), including Background (AC_BK), Best Effort (AC_BE), Video (AC_VI), and Voice (AC_VO). Generally, TIDs 1 and 2 are mapped to AC_BK; TIDs 0 and 3 are mapped to AC_BE; TIDs 4 and 5 are mapped to AC_VI; and TIDs 6 and 7 are mapped to AC_VO. Based on this, the manner of obtaining the second TID may include the following strategies: First, using an alternative TID of an AC within the same access category. For example, for the AC_BE access category (i.e., Best Effort), standards typically allow mapping both value 0 and value 3 to this category. Therefore, TID 0 can be used as the second TID and assigned to classic traffic (i.e., Low TID), while TID 3 can be used as the first TID and assigned to L4S traffic, or vice versa. Second, using a reserved TID. For example, one of TID 0 to TID 7 (e.g., TID 0) can be assigned to classic traffic, and one of TID 8 to TID 15 (e.g., TID 8, i.e., High TID) can be assigned to L4S traffic. In this scenario, the wireless communication module 120 needs to configure a mapping mechanism to map the High TID to the same access category as the classic traffic. In this way, both will have the same priority in wireless medium access, but in reordering processing at the receiver, due to having different TIDs, they will be treated as different flows and enter respective independent reordering buffers. Third, the second TID may also be an additional TID remapped from a certain access category, creating an independent logical channel by redefining the mapping relationship between TIDs and access categories. By obtaining different TIDs through any of the above methods, the receiver can establish independent block ACK sessions and reordering buffers for different TIDs, thereby avoiding the loss of classic traffic from affecting the delivery of L4S traffic.

The processor 121 of the wireless communication module 120 aggregates the first MSDU 200a from the first queue 262 and the second MSDU 200b from the second queue 264 to generate a PPDU 240. This PPDU 240 is referred to as a multi-TID PPDU because it contains data belonging to different TIDs. Subsequently, the transceiver 122 transmits the PPDU 240 to the wireless communication device 300 at the receiving end.

In the wireless communication module 310 of the wireless communication device 300, received packets are diverted to corresponding reordering buffers based on their TIDs. Specifically, the wireless communication module 310 may partition a first reordering buffer 330 and a second reordering buffer 340 in the memory unit 313. The first reordering buffer 330 is configured to process packets (i.e., first MSDUs 200a) containing the first TID and maintain a first Sequence Number (SN) space 332. The second reordering buffer 340 is configured to process packets (i.e., second MSDUs 200b) containing the second TID and maintain a second Sequence Number (SN) space 342. Since the first MSDU 200a and the second MSDU 200b are assigned different TIDs respectively, they possess independent Sequence Number (SN) counts and reordering windows at the transmission level.

FIG. 7 further illustrates the reordering status at the receiving end when processing mixed traffic. Symbol S1 and symbol S2 represent the latest reception indicators of the first reordering buffer 330 and the second reordering buffer 340, respectively, such as the next expected sequence number or the starting boundary of the reception window. As shown in FIG. 7, one or more missing packet gaps 344 appear in the second SN space 342 of the second reordering buffer 340. This implies that one or more packets of classic traffic were lost during transmission or have not yet arrived. According to the reordering mechanism, the indicator S2 is prevented from advancing, and subsequent received second MSDUs 200b must remain in the second reordering buffer 340 until the lost packet is successfully retransmitted or a timer expires. This is the common HOL blocking phenomenon under the traditional single-TID architecture.

However, benefiting from the multi-TID architecture of this embodiment, the first MSDUs 200a (L4S traffic) are located in the independent first SN space 332. The state of the first reordering buffer 330 is completely unaffected by the second reordering buffer 340. As shown, there are no gaps in the first reordering buffer 330, so the indicator S1 can continue to advance smoothly. This allows the first MSDUs 200a to be immediately pushed to the processing circuit 320 for upper-layer application processing after reception, without waiting for the lost packets of classic traffic. Thereby, the present invention effectively eliminates the HOL blocking problem that L4S traffic may suffer during mixed traffic transmission, ensuring the timeliness and user experience of low-latency applications.

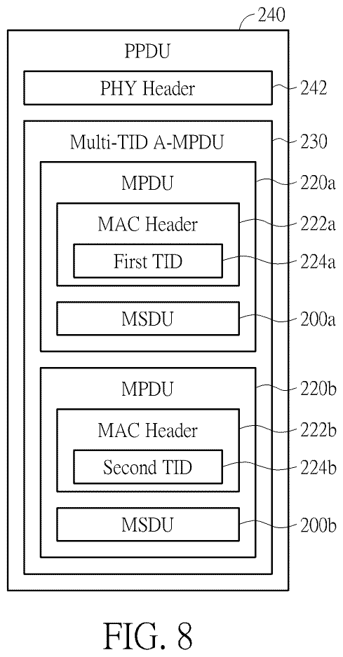

FIG. 8 is a schematic diagram illustrating a data structure of the PPDU 240 according to an embodiment of the present invention. This figure specifically illustrates the internal composition and aggregation method of the multi-TID PPDU 240 described in FIG. 7. The PPDU 240 includes a Physical layer header (PHY header) 242 and a multi-TID aggregated MAC protocol data unit (multi-TID A-MPDU) 230.

The multi-TID A-MPDU 230 is formed by aggregating multiple MPDUs. In this embodiment, the multi-TID A-MPDU 230 includes at least one first MPDU 220a and at least one second MPDU 220b. The first MPDU 220a consists of a first MAC header 222a and a first MSDU 200a. The traffic identifier field in the first MAC header 222a is filled with the aforementioned first TID 224a. Correspondingly, the second MPDU 220b consists of a second MAC header 222b and a second MSDU 200b. The traffic identifier field in the second MAC header 222b is filled with the aforementioned second TID 224b.

Referring to FIG. 7 and FIG. 8 together, FIG. 8 supplements how the multi-TID PPDU 240 in FIG. 7 implements aggregated transmission at the physical layer. Although FIG. 7 emphasizes that the first MSDUs 200a and the second MSDUs 200b logically belong to different queues within the wireless communication device 100 (first queue 262 and second queue 264) and enter different sequence number spaces at the wireless communication device 300 end (first SN space 332 and second SN space 342), FIG. 8 reveals that when these two types of packets are transmitted over the air interface, they are encapsulated in the multi-TID A-MPDU 230 structure of the same PPDU 240. This design allows the wireless communication module 120 to use a single transmission opportunity (TXOP) to simultaneously transmit latency-sensitive traffic and non-latency-sensitive traffic. This architecture solves the HOL blocking problem at the receiver through the TID diversion mechanism of FIG. 7, and maintains MAC layer transmission efficiency through the aggregation structure of FIG. 8, avoiding reduced spectrum utilization caused by excessively frequent independent transmissions.

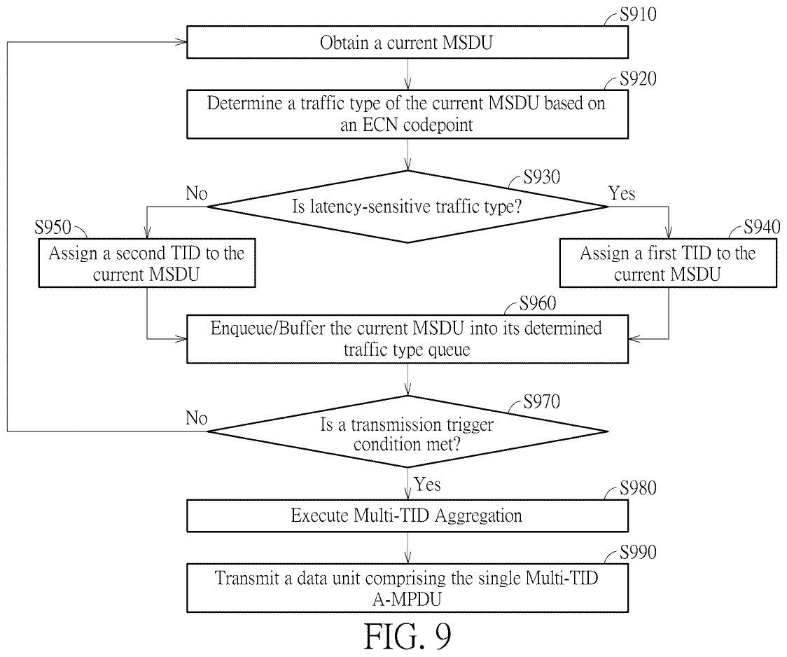

FIG. 9 is a flowchart illustrating a transmission method based on traffic identifier (TID) distribution and aggregation according to an embodiment of the present invention. The method of this embodiment may be executed by the wireless communication device 100, for example, by the processor 111 of the processing circuit 110 (corresponding to the driver layer embodiment) or the processor 121 of the wireless communication module 120 (corresponding to the firmware layer embodiment) executing instructions stored in the memory unit. This method aims to solve the blocking problem caused by different traffic types sharing the same TID or queue, while maintaining transmission efficiency.

In step S910, the processor receives or obtains a current MSDU 200. In step S920, the processor determines the traffic type of the current MSDU 200 based on the ECN codepoint 204 in the IP header 202 of the current MSDU 200.

In step S930, the processor determines whether the traffic type is a latency-sensitive traffic type. If it is determined as Yes in step S930, indicating that the current MSDU 200 is latency-sensitive traffic (e.g., L4S traffic), the flow proceeds to step S940. In step S940, the processor assigns a first TID to the current MSDU 200. The first TID is pre-configured for latency-sensitive traffic, for example, it may be a high-priority TID corresponding to an access category (AC) or a reserved TID.

If it is determined as No in step S930, indicating that the current MSDU 200 is non-latency-sensitive traffic (e.g., classic traffic), the flow proceeds to step S950. In step S950, the processor assigns a second TID to the current MSDU 200. The second TID is different from the first TID to ensure that the two are logically isolated. For example, if both belong to the same access category (e.g., Best Effort), TID 0 can be used as the second TID and TID 3 as the first TID, thereby achieving diversion without changing the access category.

After completing the TID assignment, the flow proceeds to step S960. In step S960, the processor enqueues or buffers the current MSDU 200 into its determined traffic type queue. Specifically, if assigned the first TID, it is stored in the queue corresponding to the first TID (e.g., first queue 262); if assigned the second TID, it is stored in the queue corresponding to the second TID (e.g., second queue 264).

In step S970, the processor determines whether a transmission trigger condition is met. The transmission trigger condition may include, but is not limited to: obtaining a transmission opportunity (TXOP), the amount of data in the queue reaching an aggregation threshold, or transmission waiting time expiration. If determined as “No” in step S970, the flow returns to step S910, and the processor continues to receive and process the next MSDU, accumulating it into the corresponding queue.

If determined as “Yes” in step S970, the flow proceeds to step S980. In step S980, the processor executes multi-TID aggregation. In this step, the processor retrieves data from different TID queues for aggregation. Specifically, the processor aggregates at least one first MPDU 220a associated with the first TID and at least one second MPDU 220b associated with the second TID to form a single 230. This operation ensures that packets with different QoS (Quality of Service) requirements or different reordering sequences can be encapsulated in the same transmission unit. Finally, in step S990, the processor controls the transceiver 122 to transmit a data unit (e.g., PPDU 240) comprising the single multi-TID A-MPDU 230, thereby serving data of different traffic types simultaneously in one transmission.

Furthermore, another embodiment of the present invention may integrate the data packet aggregation method of FIG. 5 with the diversion transmission method of FIG. 9 to construct a high-efficiency and low-latency transmission mechanism. In this integrated embodiment, after receiving multiple MSDUs 200, the processor of the wireless communication device 100 first checks the ECN codepoint 204 of each MSDU 200 according to the logic of FIG. 5, and forbears from mixing and aggregating MSDUs of the latency-sensitive traffic type with MSDUs of the non-latency-sensitive traffic type into the same A-MSDU. The processor aggregates multiple MSDUs belonging to latency-sensitive traffic into a pure first A-MSDU, and aggregates multiple MSDUs belonging to non-latency-sensitive traffic into a pure second A-MSDU. Then, according to the logic of FIG. 9, the processor encapsulates the first A-MSDU into a first MPDU 220a associated with a first TID, and encapsulates the second A-MSDU into a second MPDU 220b associated with a second TID. Finally, the processor executes multi-TID aggregation to merge the first MPDU 220a having the first TID and the second MPDU 220b having the second TID into a single multi-TID A-MPDU 230 and transmits it. This method ensures traffic homogeneity at the microscopic A-MSDU level, avoiding latency uncertainty caused by mixed aggregation, while achieving traffic isolation and transmission efficiency optimization at the macroscopic PPDU level using multi-TID technology.

In summary, the wireless communication device and method proposed by the present invention accurately distinguish between latency-sensitive traffic (e.g., L4S traffic) and non-latency-sensitive traffic (e.g., classic traffic) by identifying the ECN codepoint in the IP header. By forbearing from mixing heterogeneous traffic into the same A-MSDU during the aggregation process, the present invention effectively guarantees the transmission timeliness and reliability of latency-sensitive traffic. Furthermore, the present invention utilizes the diversion mechanism of multi-TID in conjunction with physical layer aggregation transmission technology, enabling traffic of different natures to enter independent reordering buffers at the receiving end. This architecture not only thoroughly solves the HOL blocking problem at the receiver caused by the loss of classic packets under the traditional single logical channel, but also takes into account both high throughput and low latency QoS requirements without sacrificing spectrum usage efficiency, significantly enhancing the support capability of wireless communication systems for emerging real-time applications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication device, comprising:
one or more memory units;
a transceiver; and
one or more processors coupled to the one or more memory units and the transceiver, wherein the one or more processors are configured to execute instructions stored in the one or more memory units to cause the wireless communication device to:
obtain a plurality of MAC service data units (MSDUs);
determine a traffic type for each of the plurality of MSDUs based on an explicit congestion notification (ECN) codepoint in an Internet protocol (IP) header thereof, wherein the traffic type is classified as either a latency-sensitive traffic type or a non-latency-sensitive traffic type;
forbear from aggregating a first MSDU and a second MSDU from the plurality of MSDUs in response to a determination that the traffic type of the first MSDU is the latency-sensitive traffic type and the traffic type of the second MSDU is the non-latency-sensitive traffic type;
aggregate at least two MSDUs from the plurality of MSDUs to form a single aggregated MSDU (A-MSDU) in response to a determination that the at least two MSDUs are all of the latency-sensitive traffic type or are all of the non-latency-sensitive traffic type; and
cause the transceiver to transmit a data unit comprising the single A-MSDU.

2. The wireless communication device of claim 1, wherein the latency-sensitive traffic type corresponds to an ECN codepoint of L4S-capable transport (ECT(1)) or congestion experienced (CE).

3. The wireless communication device of claim 1, wherein the non-latency-sensitive traffic type corresponds to an ECN codepoint of not ECN-capable transport (Not-ECT) or ECN-capable transport (ECT(0)).

4. The wireless communication device of claim 1, wherein the instructions, when executed by the one or more processors, further cause the wireless communication device to:
aggregate the at least two MSDUs to form the single A-MSDU in response to the determination that the at least two MSDUs are all of the latency-sensitive traffic type.

5. The wireless communication device of claim 1, wherein the one or more processors comprise:
a host processor; and
a processor of a wireless communication module, wherein the wireless communication module comprises the transceiver,
and wherein the host processor and the processor of the wireless communication module are configured to collectively execute the instructions to perform the aggregation and the forbearing.

6. The wireless communication device of claim 1, wherein the instructions, when executed by the one or more processors, further cause the wireless communication device to:
assign a first traffic identifier (TID) to one or more MSDUs of the latency-sensitive traffic type; and
assign a second TID, different from the first TID, to one or more MSDUs of the non-latency-sensitive traffic type.

7. The wireless communication device of claim 6, wherein the instructions, when executed by the one or more processors, further cause the wireless communication device to:
aggregate at least one first MAC protocol data unit (MPDU) associated with the first TID and at least one second MPDU associated with the second TID into a single multi-TID aggregated MPDU (A-MPDU); and
wherein the data unit transmitted by the transceiver is a physical layer protocol data unit (PPDU) that comprises the single multi-TID A-MPDU.

8. A method for data packet aggregation performed by a wireless communication device, the method comprising:
obtaining a plurality of MAC service data units (MSDUs);
determining a traffic type for each of the plurality of MSDUs based on an explicit congestion notification (ECN) codepoint in an Internet protocol (IP) header thereof, wherein the traffic type is classified as either a latency-sensitive traffic type or a non-latency-sensitive traffic type;
forbearing from aggregating a first MSDU and a second MSDU from the plurality of MSDUs in response to a determination that the traffic type of the first MSDU is the latency-sensitive traffic type and the traffic type of the second MSDU is the non-latency-sensitive traffic type;
aggregating at least two MSDUs from the plurality of MSDUs to form a single aggregated MSDU (A-MSDU) in response to a determination that the at least two MSDUs are all of the latency-sensitive traffic type or are all of the non-latency-sensitive traffic type; and
transmitting, via a transceiver, a data unit comprising the single A-MSDU.

9. The method of claim 8, wherein the latency-sensitive traffic type corresponds to an ECN codepoint of L4S-capable transport (ECT(1)) or congestion experienced (CE).

10. The method of claim 8, wherein the non-latency-sensitive traffic type corresponds to an ECN codepoint of Not ECN-Capable Transport (Not-ECT) or ECN-Capable Transport (ECT(0)).

11. The method of claim 8, further comprising:
aggregating the at least two MSDUs to form the single A-MSDU in response to the determination that the at least two MSDUs are all of the latency-sensitive traffic type.

12. The method of claim 8, further comprising:
assigning a first traffic identifier (TID) to one or more MSDUs of the latency-sensitive traffic type; and
assigning a second TID, different from the first TID, to one or more MSDUs of the non-latency-sensitive traffic type.

13. The method of claim 12, further comprising:
aggregating at least one first MAC protocol data unit (MPDU) associated with the first TID and at least one second MPDU associated with the second TID into a single multi-TID aggregated MPDU (A-MPDU); and
wherein the data unit transmitted is a physical layer protocol data unit (PPDU) that comprises the single multi-TID A-MPDU.

14. A wireless communication device, comprising:
one or more memory units;
a transceiver; and
one or more processors coupled to the one or more memory units and the transceiver, wherein the one or more processors are configured to execute instructions stored in the one or more memory units to cause the wireless communication device to:
obtain a plurality of MAC service data units (MSDUs);
determine a traffic type for each of the plurality of MSDUs based on an explicit congestion notification (ECN) codepoint in an Internet protocol (IP) header thereof, wherein the traffic type is classified as either a latency-sensitive traffic type or a non-latency-sensitive traffic type;
assign a first Traffic Identifier (TID) to one or more MSDUs of the latency-sensitive traffic type;
assign a second TID, different from the first TID, to one or more MSDUs of the non-latency-sensitive traffic type;
aggregate at least one first MAC protocol data unit (MPDU) associated with the first TID and at least one second MPDU associated with the second TID to form a single multi-TID aggregated MPDU (A-MPDU); and
cause the transceiver to transmit a data unit comprising the single multi-TID A-MPDU.

15. The wireless communication device of claim 14, wherein the latency-sensitive traffic type corresponds to an ECN codepoint of L4S-capable transport (ECT(1)) or congestion experienced (CE).

16. The wireless communication device of claim 14, wherein the non-latency-sensitive traffic type corresponds to an ECN codepoint of not ECN-capable transport (Not-ECT) or ECN-capable transport (ECT(0)).

17. The wireless communication device of claim 14, wherein the instructions, when executed by the one or more processors, further cause the wireless communication device to:
forbear from aggregating a first MSDU and a second MSDU from the plurality of MSDUs in response to a determination that the traffic type of the first MSDU is the latency-sensitive traffic type and the traffic type of the second MSDU is the non-latency-sensitive traffic type; and
aggregate at least two MSDUs from the plurality of MSDUs to form a single aggregated MSDU (A-MSDU) in response to a determination that the at least two MSDUs are all of the latency-sensitive traffic type or are all of the non-latency-sensitive traffic type.

18. A method for data packet aggregation performed by a wireless communication device, the method comprising:
obtaining a plurality of MAC service data units (MSDUs);
determining a traffic type for each of the plurality of MSDUs based on an explicit congestion notification (ECN) codepoint in an Internet protocol (IP) header thereof, wherein the traffic type is classified as either a latency-sensitive traffic type or a non-latency-sensitive traffic type;
assigning a first traffic identifier (TID) to one or more MSDUs of the latency-sensitive traffic type;
assigning a second TID, different from the first TID, to one or more MSDUs of the non-latency-sensitive traffic type;
aggregating at least one first MAC protocol data unit (MPDU) associated with the first TID and at least one second MPDU associated with the second TID to form a single multi-TID aggregated MPDU (A-MPDU); and
transmitting, via a transceiver, a data unit comprising the single multi-TID A-MPDU.

19. The method of claim 18, wherein the latency-sensitive traffic type corresponds to an ECN codepoint of L4S-capable transport (ECT(1)) or congestion experienced (CE), and the non-latency-sensitive traffic type corresponds to an ECN codepoint of not ECN-capable transport (Not-ECT) or ECN-capable transport (ECT(0)).

20. The method of claim 18, further comprising:
forbearing from aggregating a first MSDU and a second MSDU from the plurality of MSDUs in response to a determination that the traffic type of the first MSDU is the latency-sensitive traffic type and the traffic type of the second MSDU is the non-latency-sensitive traffic type; and
aggregating at least two MSDUs from the plurality of MSDUs to form a single aggregated MSDU (A-MSDU) in response to a determination that the at least two MSDUs are all of the latency-sensitive traffic type or are all of the non-latency-sensitive traffic type.
